(19) United States
(12) Patent Application Publication
(10) Pub. No.: US 2011/0184587 A1
(43) Pub. Date: Jul. 28, 2011

(54) System and Method for Trading Electrical or Other Portable Power or Energy Source

(75) Inventors: George Vamos, Studio City, CA (US); Kelly H. McClure, Simi Valley, CA (US)

(73) Assignee: Flux Engineering, LLC., Beverly Hills, CA (US)

(21) Appl. No.: 13/011,892

(22) Filed: Jan. 22, 2011

Related U.S. Application Data
(60) Provisional application No. 61/298,080, filed on Jan. 25, 2010.

(51) Int. Cl. G06F 1/26; G06Q 90/00

(52) U.S. Cl. 700/297; 705/500

(57) ABSTRACT

A method is disclosed. The method provides a user with access to a plurality of power providers, allows the user to purchase power from at least one power provider out of the plurality of power providers, and allows the user to charge a battery or operate equipment using the purchased power.

### CROSS REFERENCE TO RELATED APPLICATIONS

This application claims the benefit of U.S. Provisional Application No. 61/298,080, filed on Jan. 25, 2010, which is incorporated herein by reference in its entirety.

### FIELD

The present invention relates generally to charging and discharging a battery of an electric/hybrid vehicle.

### BACKGROUND

Concerns over rising pollution, global warming, diminishing supplies of fossil fuels and the cost of fuel has led to a greater interest in the use of electric power for powering vehicles, either using electric power alone or electric power in a hybrid vehicle which also includes a tandem internal combustion engine. Technology advances in storage cell design have made electric vehicles a viable alternative to internal combustion engines. However, the ability to recharge the storage cell/batteries remains a major obstacle to widespread adoption of these technologies. For instance, improved storage cells may give an electric vehicle a range of 100 miles at comparable speeds with internal combustion engines. This limits the user to a 50 mile radius from his home if he is a commuter, since he must make a return trip to his house in order to recharge the storage cells. The recharging typically involves a power cable connected between the vehicle and a charging station/electrical outlet located within the user's garage or dwelling. If charging stations were available in public or private locations, such as work place, parking garages, rest stops, or private parking lots associated with a particular business, the electric vehicle could be recharged in the parking space, parking lot or any other convenient or desirable venue while the owner/user is at work or shopping. The availability of such charging stations would significantly increase the range the electric vehicle could travel and encourage the purchase of the electric vehicles because the potential buyers and users would know that they were not limited to a drive or commute that was set by the amount of charge of the battery or storage cell. The availability of such charging stations would also allow the use of smaller and lighter batteries, thereby increasing or improving the efficiency and/or economics and performance and range of the electric vehicle.

A novel charging system is presently disclosed to encourage potential buyers to purchase and use electric/hybrid vehicles.

### SUMMARY

According to the present disclosure, a system of charging and/or discharging a battery or providing power to operate equipment is disclosed.

According to a first aspect, a method is disclosed, the method comprising: providing a user with access to a plurality of power providers; allowing the user to purchase power from at least one power provider out of the plurality of power providers; and allowing the user to charge a vehicle's battery using the purchased power.

According to a second aspect, a system is disclosed, the system comprising: a power connection configured to obtain power from at least one power provider; at least one power port configured to deliver power to at least one vehicle; and a database for storing one or more parameters associated with a user of a system or associated with the at least one vehicle, wherein the one or more parameters are agreed to by the user prior to using the system, wherein the system delivers power to the at least one vehicle based on the one or more parameters.

According to a third aspect, a method is disclosed, the method comprising: providing a user with access to a plurality of power providers; allowing the user to purchase power from at least one power provider out of the plurality of power providers; and allowing the user to charge a battery or operate equipment using the purchased power.

According to a fourth aspect, a method is disclosed, the method comprising: retrieving one or more parameters associated with a user, wherein the one or more parameters are agreed to by the user prior to using a system; and deliver power to the user's vehicle based on the one or more parameters.

According to a fifth aspect, a method is disclosed, the method comprising: allowing a user to negotiate one or more parameters with at least one power provider; and allowing the user to purchase power from the at least one power provider based on the one or more parameters.

According to a sixth aspect, a system is disclosed, the system comprising: a bidirectional power connection configured to obtain power from and deliver power to at least one power provider; and at least one bidirectional power port configured to deliver power to and obtain power from at least one vehicle, wherein power obtained from the at least one power provider is delivered to the at least one vehicle and wherein the power obtained from the at least one vehicle is delivered to the at least one power provider.

### BRIEF DESCRIPTION OF THE FIGURES

FIG. 1 depicts an exemplary embodiment of a charging system according to the present disclosure.

FIG. 2 depicts an exemplary embodiment of a network capable and adaptable contract negotiation according to the present disclosure.

FIG. 3 depicts an exemplary embodiment of negotiating for power according to the present disclosure.

FIG. 4a depicts an exemplary process for charging a vehicle's battery using the charging system according to the present disclosure.

FIG. 4b depicts another exemplary process for charging a vehicle's battery using the charging system according to the present disclosure.

FIG. 4c depicts an exemplary process for charging and/or discharging a vehicle's battery using the charging system according to the present disclosure.

FIG. 5 depicts an exemplary process for matching user's request for services with parameters in a contract according to the present disclosure.

FIG. 6 depicts an exemplary process for providing power to a client using the charging system according to the present disclosure.

FIG. 7 depicts an exemplary process for matching client's request for services with parameters in a contract according to the present disclosure.

In the following description, like reference numbers are used to identify like elements. Furthermore, the drawings are intended to illustrate major features of exemplary embodiments in a diagrammatic manner. The drawings are neither intended to depict every feature of every implementation nor relative dimensions of the depicted elements and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Although charging stations for electric/hybrid vehicles are well known in the art, they are analogous to gas stations, home wall plugs or other power/energy transfer means in terms of allowing the users to plug their cars and having the user pay a pre-set retail price without facilitating negotiable and mutable terms. Besides charging a pre-set, flat rate for charging the vehicle, the charging stations known in the art also deliver power to the charging vehicle at a constant rate. By not being able to vary the charging rate, the charging stations known in the art require the users to wait up to several hours in order to charge their vehicles with enough power to allow the users to get to their destination. Similarly, by not being able to vary the charging rate the number of vehicles that may be charged is limited by the available power.

Contrary to the prior art, present disclosure provides a charging system that, for example: (a) can be easily implemented at the employers facilities and/or shopping centers to allow the users of the electric/hybrid vehicles to save time and charge their vehicles while working and/or shopping; (b) allows the electric/hybrid vehicles to recharge from an on-site generated power or power utilities; (c) provides a means for an employer or other commercial entity to deliver power as pre-tax compensation or consideration; (d) allows the user of the electric/hybrid vehicles to negotiate the price for charging their vehicle; (e) is capable of varying the amount of power being delivered to the user's vehicle; (f) allows the recharging vehicle to become temporary emergency or peak load power source for operator of network, such as utility, employer, government, or landlord; and/or (g) can be configured to connect to and obtain power from portable generators, hybrid or internal combustion vehicles, and/or any other power generating device.

In one exemplary embodiment, the charging system according to the present disclosure may be configured to allow employers an opportunity to arbitrage pre-tax commercial electrical power against after-tax gasoline, and use the difference between gasoline costs and electrical power, plus about 50% of retail energy cost of the electrical cost to reduce employer compensation/remuneration for labor costs.

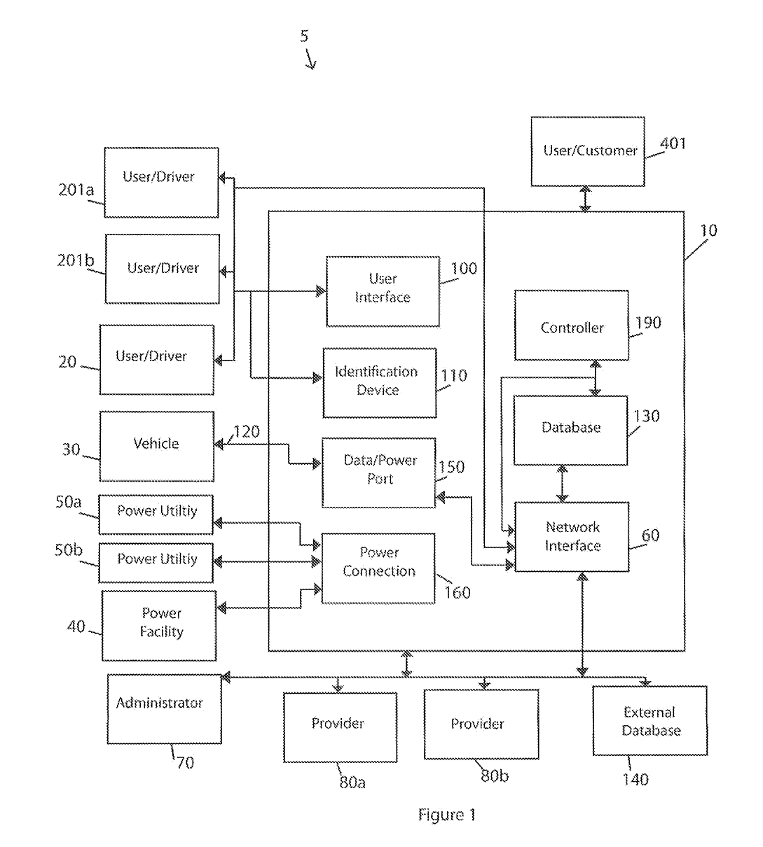

For example, for employees who drive electric or plug-in hybrid vehicles, the employer may permit the employees to charge their cars while parked at work or at any other venue that provides the charging system according to the present disclosure. The employer buys the power at the commercial rate (for example, $.16/kw/hr at current rates pre-tax) and assumes the cost of powering the employees' cars, thereby replacing gasoline (for example, $3/gallon at current rates, but $3.99 in pre-tax salary per gallon assuming a 33% marginal tax rate). The employees' wages may be fixed so the employees' discretionary income may remain the same, adjusted for whatever incentive is required to motivate the employee. The difference in wages (gross profit) plus any government and other incentives is divided between the employer(s), employees, and/or any combination of both, as well as other interested parties, and the company providing the service to the employer. The employer pays the employees a salary with about the same purchasing power and keeps the difference, minus the fees paid to the company providing the actual service. The employer may provide the service and infrastructure as described below with reference to FIG. 1, or may contract with a third party to provide this service at the employer's facility.

In another exemplary embodiment, the charging system according to the present disclosure may be configured to allow the charging stations to vary the charge rate, and even reverse it when there is, for example, a power outage/shortage. For example, the employer can use the cars attached to the charging stations to do short term power trading with the power utilities by selling power stored in the cars back to the power utilities when the power is scarce and buying the power back from the power utilities when there is an excess of generation available, allowing it to be purchased at a lower cost. For purposes of the following matter, power and energy transfer may be considered interchangeable, except where the invention describes transferring energy under various timing needs and constraints (power).

Electric/hybrid vehicles are a movable power reserve. If an electric/hybrid vehicle can travel at 55 mph on the freeway at 10 kw, the electric/hybrid vehicle may potentially provide that energy back into the power/utility grid while standing still. The following example may be used to demonstrate the amount of power that may be potentially provided back into the power/utility grid by the electric/hybrid vehicles when they are not being used. For example, if the electric/hybrid vehicle has a range of about 150 miles that means the electric/hybrid vehicle's battery is capable of storing about 60 kw/h. If the driver of that electric/hybrid vehicle insists that the electric/hybrid vehicle be charged at least 75% that means that about 25% (i.e. 15 kw/h) of the stored power can be provided back to the utility grid when the electric/hybrid vehicle is fully charged. That means with 100 million electric/hybrid vehicles there is potentially a power reserve of about 1.5 billion kilowatt hours. If only 10% of this power reserve is sent back into the power/utility grid over a 10 hour period, it would be equivalent to having extra 15 normal sized (1 GW) nuclear reactors generating power. Since there are about 100 nuclear reactors in the United States, that is an increase of about 15%.

Most vehicle batteries are partially charged, and partially charged batteries can either accept or deliver power. On command via the system described below with reference to FIG. 1, these vehicle batteries can instantly become dispatchable generators or dispatchable loads. The dynamic range of 100 million cars from both modes may equal to twenty 1 GW reactors, but it is also geographically distributed. The environmental, reliability and safety consequences of this distribution are significant. If half the cars are plug in hybrids, one may even turn their motors on, there by further increasing the amount of peak and average power that may be provided back into the power/utility grid.

In another exemplary embodiment, the charging system according to the present disclosure may be configured to allow stores to provide incentives for their customers to shop by allowing the customers to charge their vehicles for free or at a reduced rate if the customer makes a purchase. For example, at the point of sale, information may be transmitted through an internet network to the charging system according to the present disclosure allowing and/or crediting the customer with future power. The amount of credit received by the customer may be based upon the type of purchase or amount of monies spent at the store. The charging system according to the present disclosure may also be configured to provide bonus power to the customers based on their shopping loyalty with a particular store. Providing such a benefit to customers may increase customer loyalty as well as the amount of time spent at a given shopping venue.

Referring to FIG. 1, in one exemplary embodiment, the charging system 5 according to the present disclosure may have a recharging/power exchange station 10 configured to interact with a driver/user 20, configured to charge or discharge at least one electric/hybrid vehicle 30, configured to obtain power from or deliver power to an on-site power facility 40 or an external power/utility grid 50a or an external power/utility grid 50b, and configured to have access to external system/data and/or allow access by an administrator 70 through a network interface 60. The charging system 5 may further have a power interface 120 to the vehicle 30, such as, for example, an electric cable, with the ability to recharge the batteries of the vehicle 30 and/or obtain data from the vehicle 30. The data that may be obtained from the vehicle 30 may be identification of the driver/user 20, status of the vehicle 30, amount of power required by the vehicle 30, and/or amount of power available to be removed from the vehicle 30. Although two external power/utility grids 50a-b are described in FIG. 1, it is to be understood that the charging system 5 according to the present disclosure may also be configured to only operate with only one external power/utility grid 50a or with more than two external power/utility grids 50a-b.

Referring to FIG. 1, in another exemplary embodiment, the charging system 5 according to the present disclosure may be configured to provide power to user/customer 401. In this exemplary embodiment, the user/customer 401 may be a private residence, office building, hospital or any other facility that requires power to operate equipment such as, for example, lights, air conditioner, appliances, etc. In this exemplary embodiment, the recharging/power exchange station 10 may be configured to interact with the customer 401, may be configured to provide power to the customer 401, may be configured to obtain power for the customer 401 from the vehicle 30, the on-site power facility 40 or the external power/utility grids 50a-b, and may be configured to have access to external system/data and/or allow access by the administrator 70 through the network interface 60.

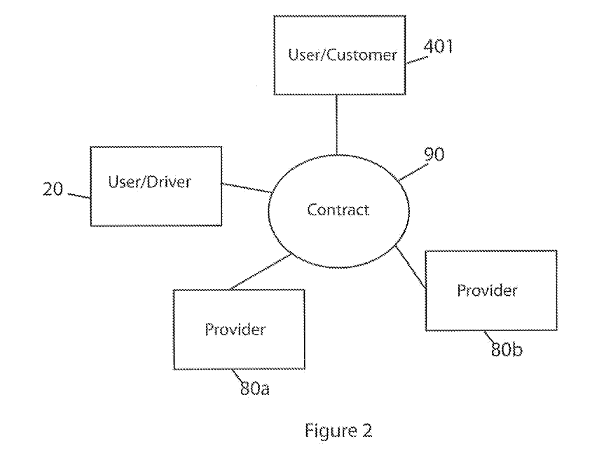

Referring to FIG. 2, in one exemplary embodiment, before using station 10, the driver/user 20 and/or the customer 401 would negotiate and accept a contract 90 with a provider 80a and/or provider 80b. The contract 90 may provide parameters that govern the relationship between the driver/user 20, the customer 401, the provider 80a and/or the provider 80b. The contract 90 may also provide parameters that govern the relationship between the vehicle 30 and the provider 80a and/or the provider 80b. The contract 90 may further provide parameters that govern the power transactions that occur when the vehicle 30 is connected with the charging system 5. The contract 90's parameters may, for example: (a) specify the identity of the contracting parties such as, for example, the driver/user 20, the customer 401, the provider 80a and/or provider 80b; (b) specify the limits on the power to be exchanged (e.g. 50 Kw/h per week maximum delivered to the customer 401 or the vehicle 30); (c) specify possible cost constraints (e.g. maximum price of $0.08/Kw/h); (d) specify maximum charging rate allowed during the time the customer 401 and/or the vehicle 30 are being charged; (e) specify if and/or when power may be taken from the driver/user 20's vehicle 30; (f) specify access levels; (g) specify direct or indirect monetary compensation, and/or (e) specify payment for power taken from the vehicle. In one exemplary embodiment, the contract 90 may be an electronic record that may be stored in a database 130 and/or external database 140 and it may be served locally at the station 10, via internet or other distributed data transfer means.

Parameters in the contract 90 may also specify the following exemplary rules and preferences of the contracting parties such as, for example, the driver/user 20, the customer 401, the provider 80a and/or the provider 80b: (1) on weekdays, the vehicle 30 should have, for example, at least 15 Kw/h of power available after being connected with the charging system 5 for at least one hour. This would allow the user/driver 20 to use the vehicle 30 in case there is an emergency and the driver/user 20 unexpectedly needs to travel; (2) on weekdays, the vehicle 30 should have between 20 Kw/h and 30 Kw/h of power, or at least enough power to get back home or to another charging facility, by the end of the workday; (3) between 9 AM and 12 PM, the provider 80a and/or the provider 80a may withdraw power from the vehicle 30, so long as the power level does not drop below, for example, 15 Kw/h. This would allow the provider 80a and/or the provider 80b to use the power from the vehicles 30 in case of a power outage or an emergency or another unanticipated need and this would allow the driver/user 20 to sell the extra power stored in the vehicle 30 while it is not being used; (4) between 1 PM and 5 PM, the provider 80a and/or the provider 80b may withdraw power from the vehicle 30, but if it drops below, for example, 20 Kw/H, each Kw/H is to be credited or purchased at a pre-negotiated rate which may be a higher rate to compensate the user/driver 20 for not having a fully charged vehicle 30 by the time the user/driver 20 is ready to leave work; (5) the driver is willing to pay $0.02 if “green” (environmentally friendly) power is available; and/or (6) the business may have a limited amount of power to deliver over time, and the price may depend on the current situation. (e.g. An apartment house may only be able to guarantee adding 15 Kw/h overnight (car parked at 7 PM, driving away at 7:30 AM) per car in the garage at $0.10, but may deliver an extra 10 Kw, but at a price of $0.20. Note: This can only occur if the driver modifies or renegotiates the contract to buy the more expensive power.

The contract 90 may determine the behavior limits of the charging system 5 when the vehicle 30 is attached. The actual behavior may be determined dynamically, depending on the instantaneous supply and demand for power, and possibly the near term projected supply and demand. For example, on a hot summer afternoon, the system may charge the vehicles 30 to a high level in the morning, so that between 2-4 PM the system may withdraw some of that power for air conditioning. This would smooth the demand the provider 80a and/or the provider 80b places on the utility company, and thereby creates an incentive for a power discount from the utility company.

Additionally, the contract 90 may contain the history of the power exchanges between the contracting parties, which may be used to support billing, contract modification as well as to predict future supply and demand for power.

Since the terms of the contract are determined by the contracting parties, it may be possible that there would not be an exchange of power. For example, the user/driver 20 or the customer 401 may want to buy power below $0.09/kw/h, but the power is only available at $0.10/Kw/h. In this example, the user/driver 20's vehicle 30 or the customer 401 will not be provided with power until the price of power drops to below $0.09/Kw/h. Similarly, it may also be possible that the terms represent the buying and selling of power delivery options, but the conditions of exercising these options have not yet occurred.

The contract 90 may be negotiated and/or accepted at the time of hire or at any other time by the employer and/or using internet, telephone, or using interface 100. The providers 80a-b may be parking lot operators, property management companies, employers, landlords, broker, public utility, retailer, anyone who operates and/or owns charging system 5 described in the present disclosure. The providers 80a-b may own generating equipment (e.g. roof top generating equipment). Although two providers 80a-b are described in FIGS. 1-3, it is to be understood that the charging system 5 according to the present disclosure may also be configured to only operate with only one provider 80a or with more than two providers 80a-b.

Once the contract 90 is accepted by driver/user 20, the customer 401, the provider 80a and/or provider 80b, the contract 90 may be stored by the provider 80a, the provider 80b and/or the administrator 70 in a database 130 stored in the memory of the station 10. In another exemplary embodiment, the contract 90 may be stored by the provider 80a, the provider 80b and/or the administrator 70 remotely in an external database 140 and retrieved by the station 10 using network interface 60. The external database 140 may reside on an administrative server, the employer's computer, or a third party server.

In one exemplary embodiment, the parameters contained in the contract 90 and/or the contract 90 may be accessed/changed/amended/updated by the user/driver 20, the customer 401, the provider 80a, the provider 80b, and/or the administrator 70. The user/driver 20, the customer 401, the provider 80a, the provider 80b and/or administrator 70 may access/change/amend/update the parameters of the contract 90 and/or the contract 90 through the user interface 100 or by remotely login into the database 130 through network interface 60 or by remotely login into the external database 140. It is to be understood that the user/driver 20, the customer 401, the provider 80a, the provider 80b and/or the administrator 70 may also access/change/amend/update the parameters of the contract 90 and/or the contract 90 using PDA, SmartPhone, built-in aftermarket vehicle accessory, vocal commands, and/or GPS system configured to communicate with the presently disclosed charging system 5.

In another exemplary embodiment, the parameters in the contract 90 and/or the contract 90 may also be accessed/changed/amended/updated by the charging system 5 by making a record of the services requested by the user/driver 20 or the customer 401, making a record of the history of use, and/or the services provided by the charging system 5.

Once the contract 90 is accepted, the driver/user 20 or the customer 401 may interact with the station 10 using, for example, user interface 100 and/or identification device 110. The user interface 100 and/or the identification device 110 may be configured to confirm the identity of the driver/user 20 or the customer 401 using, for example, driver/user 20's credit card, RFID device, biometrics, vehicle's transponder, employee identification card, pin code or some other means, including, for example, automatic recognition of the vehicle 30 connected to the station 10's data/power port 150 using power interface 120.

Once the identity of the driver/user 20 or the customer 401 has been established/confirmed, the station 10 may retrieve driver/user 20's or the customer 401's contract 90 and provide power/services according to the parameters outlined in the contract 90 previously negotiated by that driver/user 20 or that customer 401.

In another exemplary embodiment, the station 10 may be connected with the on-site power facility 40 and/or the external power utility grid 50a and/or the external power utility grid 50b though a power connection 160. The on-site power facility 40 may be run and operated by the employer or the owner of the charging system 5. The on-site power facility 40 may generate power to charge vehicles 30 or power the customer 401 using, for example, solar panels, wind turbines or any other clean source of energy. The external power utility grids 50a-b may be run and operated by a public utility company, individuals, corporations or government entity. The power connector 160 may also be a bidirectional system allowing the power to flow to and from the on-site power facility 40 and/or the external power utility grid 50a and/or the external power utility grid 50b.

Once the vehicle 30 is connected to the station 10's data/power port 150 and the driver/user 20's identity has been confirmed, station 10's controller 190 may retrieve driver/user 20's contract 90 and deliver or retrieve power according to the parameters outlined in that driver/user 20's contract 90. The data/power port 150 may be a bidirectional system for delivering power to the vehicles 30 as well as obtaining power from the vehicles 30's batteries or generation capability such as gasoline or diesel motor. In one exemplary embodiment, a traditional vehicle with a regular combustion engine may be used to deliver power to the station 10 through the data/power port 150. The bidirectional system of the data/power port 150 may allow the vehicle 30 to become a temporary emergency or peak load power source for other vehicles connected to the charging system 5 or station 10, the external power utility grid 50a, the external power utility grid 50b, and/or on-site power facility 40. This power may be sourced from the vehicle 30's battery, generator, alternator, or any combination of the above. The charging system 5 can provide a means of power sharing (load balancing) so that drivers/users 20 can receive more or less power depending on contracted priority, available energy, payment rate, charge deadline or other priority parameters provided in the contract 90.

In one exemplary embodiment, the charging system 5 may support multiple providers 80 and may allow the user/driver 20 or the customer 401 to accept different contracts 90 from multiple providers 80a and 80b. This may require user/driver 20 or the customer 401 to maintain different identifications for each of the accepted contracts 90. Once the driver/user 20 or the customer 401 present their identification to the station 10, the charging system 5 may, for example, use controller 190 of the station 10 to lookup database 130 and/or external database 140 to determine which provider 80a or 80b and/or which contract 90 will fulfill/control the requested transaction. If more than one provider 80 and/or contract 90 is associated with driver/user 20's or the customer 401's identification, the charging system 5 may optionally contain rules indicating the preferred provider 80a or 80b and /or contract 90 to be used in a particular situation and/or at a particular station 10.

It is to be understood that the driver/user 20 or the customer 401 may use one or more of the following as their identification: driver/user 20's credit card, driver license, RFID device, biometrics, vehicle's transponder, employee identification card, pin code, license plate recognition system, or some other means, including, for example, automatic recognition of the vehicle 30 connected to the station 10's data/power port 150 using power interface 120.

Using the bidirectional power connection 160 and bidirectional data/power port 150 may allow the driver/user 20 to obtain power from and sell power to the on-site power facility 40, the external power utility grid 50a and/or the external power utility grid 50b. The power obtained from the drivers/users 20 may be used as emergency power for the customer 401, private homes, hospitals, civil defense, local, state or federal government, military or other emergency service.

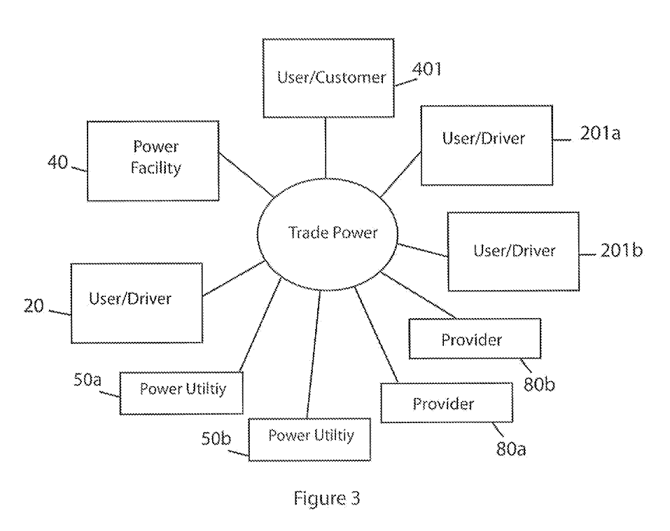

Referring to FIG. 3, in another exemplary embodiment, the charging system 5 according to the present disclosure may be configured to allow the users/drivers 20 shop for the best possible prices when either purchasing power to charge their vehicles or selling the power stored in their vehicles. The charging system 5 according to the present disclosure may also be configured to allow the customer 401 to shop for the best possible prices when purchasing power to operate equipment. When purchasing power, the user/driver 20 or the customer 401 may be allowed to negotiate with the external power utility grid 50a, the external power utility grid 50b, the provider 80a, the provider 80b, the on-site power facility 40, other drivers/users 201a-b whose vehicles (not shown) may also be connected to the charging system 5, and/or any other power providers that may be connected to the charging system 5 for the lowest possible price before purchasing the required power. Similarly, when selling power, driver/user 20 may also be allowed to negotiate with the external power utility grid 50a, the external power utility grid 50b, the provider 80a, the provider 80b, the on-site power facility 40, the customer 401, other drivers/users 201a-b connected to the charging system 5, or any other power provider that may be connected to the charging system 5 for the highest possible price. In one exemplary embodiment, the negotiation for the purchase and sale of power may be in a form of an electronically supported bidding process. Specifically, the external power utility grid 50a, the external power utility grid 50b, the on-site power facility 40, other drivers/users 201a-b and/or other power providers may bid against each other in an effort to give the user/driver 20 or the customer 401 the lowest possible selling price. Similarly, the user/driver 20 would also bid against other power providers when trying to sell the extra power stored in their vehicle.

Although presently disclosed system pertains to electric/hybrid vehicles, it is to be understood that the electric/hybrid vehicles are not only limited to cars. It is to be understood that presently disclosed charging system may also be configured to work with trucks, boats, barges, ships, airplanes or space-crafts.

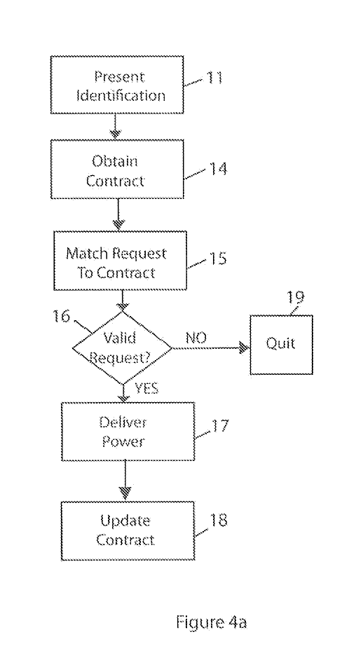

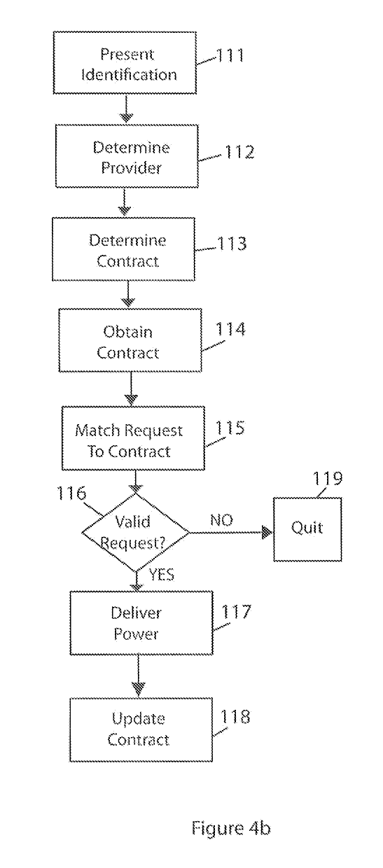

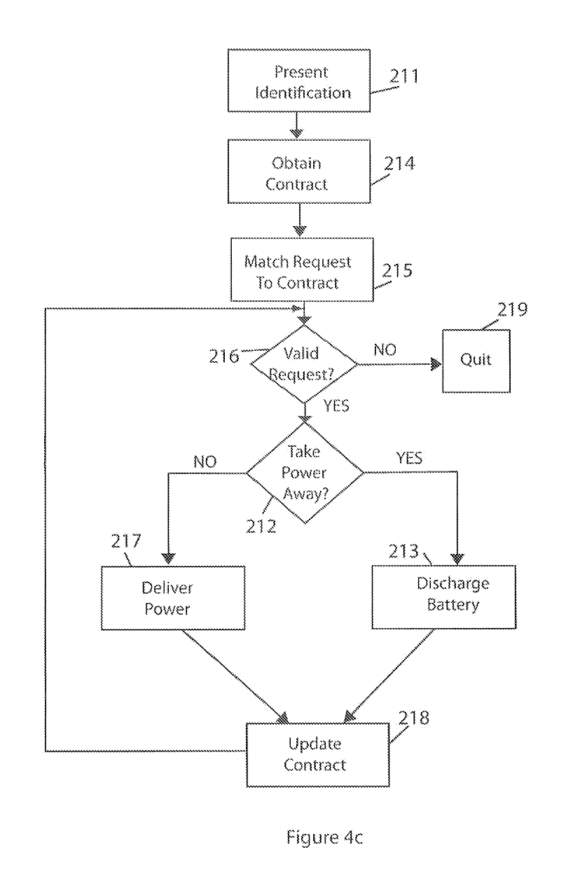

Referring to FIG. 4a, the following exemplary process may be used to charge vehicle 30's battery using charging system 5 according to the present disclosure. Referring to step 11, user/driver 20 presents identification to the station 10. As described above, the following could be used as user/driver 20's identification: driver/user 20's credit card, driver license, RFID device, biometrics, vehicle's transponder, employee identification card, pin code or some other means, including, for example, automatic recognition of the vehicle 30 connected to the station 10's data/power port 150 using power interface 120. Referring to step 14, the charging system 5 obtains user/driver 20's contract 90. The contract 90 may be obtained from database 130 and/or external database 140. Referring to step 15, the charging system 5 determines if the actions requested by the user/driver 20 are allowed under the contract 90 by matching the request to one or more parameters in the contract 90. Referring to step 16, if the user/driver 20's request is allowed under the contract 90, the charging system 5 will deliver power to the vehicle 30 based on one or more parameters in the contract 90, as shown in step 17, and will update the contract 90 by making a record of the executed request, as shown in step 18. If user/driver 20's request is not allowed under the contract 90, the request is not performed, as shown in step 19.

Referring to FIG. 4b, the following exemplary process may also be used to charge vehicle 30's battery using the charging system 5 according to the present disclosure. This exemplary process may be used when user/driver 20 negotiates multiple contracts 90 with provider 80a and 80b. Referring to step 111, user/driver 20 presents identification to the station 10. Referring to steps 112 and 113, the charging system 5 determines which provider 80a or 80b and/or which contract 90 will fulfill/control the transaction requested by the user/driver 20. Referring to step 114, the charging system 5 obtains user's/driver's contract 90. Referring to step 115, the charging system 5 determines if the actions requested by the user/driver 20 are allowed under the contract 90 by matching the request to one or more parameters in the contract 90. Referring to step 116, if the user/driver 20's request is allowed under the contract 90, the charging system 5 will deliver power to the vehicle 30 based on one or more parameters in the contract 90, as shown in step 117, and will update the contract 90 by making a record of the executed request, as shown in step 118. If user/driver 20's request is not allowed under the contract 90, the request is not performed, as shown in step 119.

Referring to FIG. 4c, the following exemplary process may be used to charge/discharge vehicle 30's battery using charging system 5 according to the present disclosure. Referring to step 211, user/driver 20 presents identification to the station 10. Referring to step 214, the charging system 5 obtains user/driver 20's contract 90. Referring to step 215, the charging system 5 determines if the actions requested by the user/driver 20 are allowed under the contract 90 by matching the request to one or more parameters in the contract 90. Referring to step 216, if the user/driver 20's request is allowed under the contract 90, the charging system 5 will deliver power to the vehicle 30 based on one or more parameters in the contract 90, as shown in step 217, and will update the contract 90 by making a record of the executed request, as shown in step 218. If user/driver 20's request is not allowed under the contract 90, the request is not performed, as shown in step 219. In one exemplary embodiment, the reasons for the denial of the request may be recorded for review and/or examination by the user 20, provider 80a and/or provider 80b. Referring to step 212, if the charging system 5 determines that the vehicle 30's power is required for other uses due to emergency or due to parameters of the contract 90, the charging system will discharge the vehicle 30's battery and utilize the power as required. Once enough power has been removed from the vehicle 30's battery, the charging system 5 will update the contract 90 by making a record of the discharge, as shown in step 218, and will restart power delivery back to the vehicle 30's battery, as shown in step 217. If the charging system 5 determines that power from the vehicle is not required, the charging system 5 will update the contract 90 by making a record of the executed request. It is to be understood that steps 217, 218, 212 and 213 may be repeated multiple times throughout the time the vehicle 30 is connected to the charging system 5 depending on the requirements of the charging systems 5.

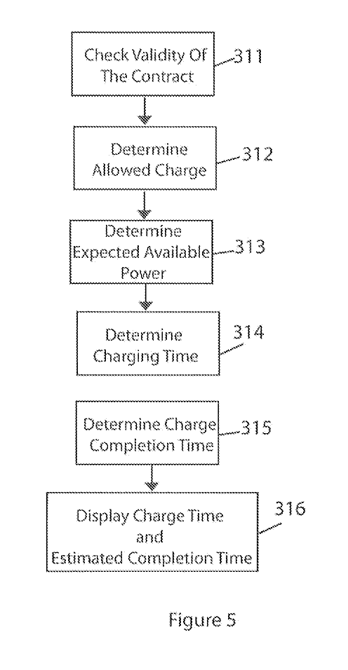

Referring to FIG. 5, the following exemplary process may be used to match the user/driver 20's request for services to one or more parameters in the contract 90 described above in steps 15, 115 and 215 with reference to FIGS. 4a-c. Referring to step 311, the charging system 5 determines if the parameters in the contract 90 and/or contract 90, obtained in the exemplary steps 14, 114 or 214, is still valid. If the contract 90 is determined to be invalid, the charging system 5 may allow the user/driver 20 to update/change/amend the contract 90 and/or the parameters of the contract 90 or the charging system 5 may terminate the user/driver 20's request for services. Once the validity of the contract 90 and/or validity of the parameters in the contract 90 has been established, the charging system 5 may determine how much charge is to be delivered to the vehicle 30, as shown in step 312. The charging system 5 may determine the amount of charge to be delivered based on the parameters in the contract 90 and/or input from the user/driver 20 and/or by directly checking vehicle 30's battery status through the power interface 120. As described above, the charging system 5 may be configured to obtain power from or deliver power to the on-site power facility 40, the external power utility grid 50a or an external power utility grid 50b. Because the supply of power available to the charging system 5 may vary on a daily, weekly and/or monthly basis, the charging system 5 may determine, as shown in step 313, availability of total power for the charging system 5 from which to charge the vehicle 30. The amount of power that is available to the charging system 5 may vary because there might be greater demand for power such as air-conditioning during hot summer day or there might be less power being produced by the solar panels during a rainy day. To determine the amount of power available to the charging system 5, the charging system 5 may rely on the past history of available power, on weather reports, building power management, and/or any other available data to more accurately determine the amount of power available for charging the vehicle 30. Once the charging system 5 determines the amount of power that is available, the charging system 5 may determine charging time allocated for the vehicle 30, as shown in step 314. The charging system 5 may determine the charging time based on the parameters in the contract 90. For example, the parameters in the contract 90 may specify that the user/driver 20 will be at work for eight hours which would allow the charging system 5 eight hours to supply the required/requested charge to the user/driver 20's vehicle 30. The charging system 5 may also determine the charging time based on the history of user/driver 20's previous charging times, and/or based on user/driver 20's input through the interface 100, and/or based on the operating conditions/hours of the charging system 5 or station 10. Once the charging system 5 determines the charging time allocated for the vehicle 30, the charging system 5 may determine the time when the vehicle 30 will be once again ready for use, as shown in step 315. The charging time allocated for the vehicle 30 and the time when the vehicle 30 will be ready for use may be displayed to the user/drive 20 using interface 100 as shown in step 316. Should the user/driver 20 need to use the vehicle 30 sooner than displayed on the interface 100, the charging system 5 may be configured to allow the user/driver 20 to amend/change/update one or more parameters of the contract 90 and/or amend/change/update the contract 90 to allow for faster charge of the vehicle 30.

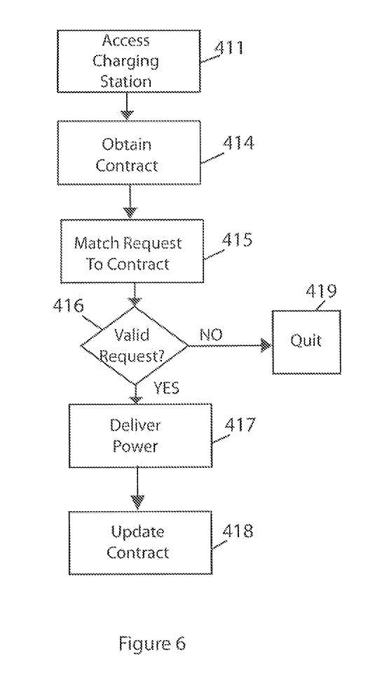

Referring to FIG. 6, the following exemplary process may be used to provide power to the customer 401 using the charging system 5 according to the present disclosure. Referring to step 411, the customer 401 accesses the charging system 5 either through the identification device 110 or remotely through the network interface 60. As described above, the following could be used as the customer 401's identification: RFID device, biometrics, identification card, pin/password code or some other means. Referring to step 414, the charging system 5 obtains the customer 401's contract 90. The contract 90 may be obtained from database 130 and/or external database 140. Referring to step 415, the charging system 5 determines if the actions requested by the customer 401 are allowed under the contract 90 by matching the request to one or more parameters in the contract 90. Referring to step 416, if the customer 401's request is allowed under the contract 90, the charging system 5 will deliver power to the customer 401 based on one or more parameters in the contract 90, as shown in step 417, and will update the contract 90 by making a record of the executed request, as shown in step 418. If the customer 401's request is not allowed under the contract 90, the request is not performed, as shown in step 419.

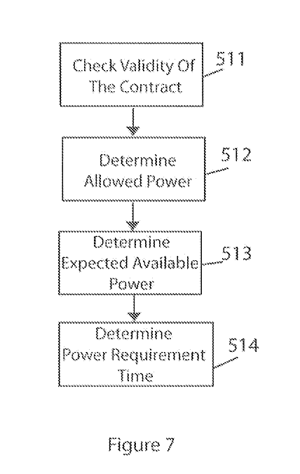

Referring to FIG. 7, the following exemplary process may be used to match the customer 401's request for services to one or more parameters in the contract 90 described above in step 415, with reference to FIG. 6. Referring to step 511, the charging system 5 determines if the parameters in the contract 90 and/or contract 90, obtained in the exemplary step 514 is still valid. If the contract 90 is determined to be invalid, the charging system 5 may allow the customer 401 to update/change/amend the contract 90 and/or the parameters of the contract 90 or the charging system 5 may terminate the customer 401's request for services. Once the validity of the contract 90 and/or validity of the parameters in the contract 90 have been established, the charging system 5 may determine how much power is to be delivered to the customer 401, as shown in step 512. The charging system 5 may determine the amount of power to be delivered based on the parameters in the contract 90 and/or input from the customer 401. As described above, the charging system 5 may be configured to obtain power from or deliver power to the on-site power facility 40, the external power utility grid 50a or the external power utility grid 50b. Because the supply of power available to the charging system 5 may vary on a daily, weekly and/or monthly basis, the charging system 5 may determine, as shown in step 513, availability of total power for the charging system 5 from which to power the customer 401. The amount of power that is available to the charging system 5 may vary because there might be greater demand for power such as air-conditioning during hot summer day or there might be less power being produced by the solar panels during a rainy day. To determine the amount of power available to the charging system 5, the charging system 5 may rely on the past history of available power, on weather reports, building power management, and/or any other available data to more accurately determine the amount of power available for powering the customer 401. Once the charging system 5 determines the amount of power that is available, the charging system 5 may determine power time allocated for the customer 401, as shown in step 514. The charging system 5 may determine the power requirement time based on the parameters in the contract 90. For example, the parameters in the contract 90 may specify that the customer 401 will require the use of air conditioner from 2 PM to 5 PM which would allow the charging system 5 to allocate enough power throughout the day to supply the required/requested power to the customer 401. The charging system 5 may also determine the power requirement time based on the history of the customer 401's previous power times, and/or based on the customer 401's input through the interface 100, and/or based on the operating conditions/hours of the charging system 5 or station 10. Once the charging system 5 determines the power requirement time for the customer 401, the charging system 5 may distribute the power across the network to make sure the customer 401's requirements are met. Should the customer 401 need extra power, the charging system 5 may be configured to allow the user 401 to amend/change/update one or more parameters of the contract 90 and/or amend/change/update the contract 90 to allow for the extra power.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

What is claimed is:

1. A method comprising:
providing a user with access to a plurality of power providers;
allowing the user to purchase power from at least one power provider out of the plurality of power providers; and
allowing the user to charge a vehicle's battery using the purchased power.

2. The method of claim 1, wherein the at least one power provider is another user.

3. The method of claim 1, wherein the at least one power provider is a power utility company.

4. The method of claim 1, wherein the at least one power provider is user's employer.

5. The method of claim 1, the method further comprising:
allowing one or more power providers out of the plurality of power providers to purchase power stored in the vehicle's battery.

6. The method of claim 5, wherein the one or more power providers are one or more other user.

7. The method of claim 5, wherein the one or more power providers are one or more power utility companies.

8. The method of claim 5, wherein the one or more power providers is user's employer.

9. The method of claim 1, the method further comprising:
negotiating one or more parameters between the user and the at least one power provider, wherein allowing the user to charge a vehicle's battery is based on the one or more parameters.

10. The method of claim 5, the method further comprising:
negotiating one or more parameters between the user and the one or more power providers, wherein allowing the one or more power providers out of the plurality of power providers to purchase power is based on the one or more parameters.

11. A system comprising:
a power connection configured to obtain power from at least one power provider;
at least one power port configured to deliver power to at least one vehicle; and
a database for storing one or more parameters associated with a user of a system or associated with the at least one vehicle,
wherein the one or more parameters are agreed to by the user prior to using the system,
wherein the system delivers power to the at least one vehicle based on the one or more parameters.

12. The system of claim 11, further comprising:
a controller configured to identity the user and retrieve the one or more parameters from the database.

13. The system of claim 11, further comprising:
a network interface configured to allow the user or the at least one power provider or a system administrator to remotely access the database or the one or more parameters.

14. The system of claim 11, wherein the power connection is configured to deliver power to the at least one power provider from the at least one vehicle.

15. The system of claim 11, wherein the at least one power port is configured to obtain power from the at least one vehicle.

16. The system of claim 15, wherein the power from the at least one vehicle is used to charge a battery or operate equipment.

17. The system of claim 11, further comprising:
an identification device configured to obtain identity of the user or the at least one vehicle.

18. The system of claim 11, wherein the at least one power port is configured to obtain data from the at least one vehicle.

19. The system of claim 18, wherein the data is user's identification, the at least one vehicle's power requirements, or any other information that would allow the system to identity the one or more parameters.

20. The system of claim 11, wherein the at least one power provider is another user's vehicle.

21. The system of claim 11, wherein the at least one power provider is a power utility company.

22. The system of claim 11, wherein the at least one power provider is the user's employer.

23. The system of claim 11, wherein the one or more parameters govern relationship between the user and the at least one power provider.

24. The system of claim 11, wherein the one or more parameters specify identity of the user or the power provider

25. The system of claim 11, wherein the one or more parameters specify an amount of power to be delivered to the at least one vehicle.

26. The system of claim 11, wherein the one or more parameters specify cost for the power to be delivered to the at least one vehicle.

27. The system of claim 11, wherein the one or more parameters specify rate at which power to be delivered to the at least one vehicle.

28. The system of claim 11, wherein the one or more parameters specify access levels.

29. The system of claim 15, wherein the one or more parameters specify amount of power to be obtained from the at least one vehicle.

30. The system of claim 15, wherein the one or more parameters specify payment for power obtained from the at least one vehicle.

31. The method of claim 11, wherein the at least one power provider is another vehicle.

32. The method of claim 11, wherein the at least one power provider is a power utility company.

33. A method comprising:
providing a user with access to a plurality of power providers;
allowing the user to purchase power from at least one power provider out of the plurality of power providers; and
allowing the user to charge a battery or operate equipment using the purchased power.

34. The method of claim 33, wherein the at least one power provider is a battery of a vehicle.

35. The method of claim 33, wherein the at least one power provider is a power utility company.

36. The method of claim 33, wherein the at least one power provider is the user's employer.

37. The method of claim 33, wherein the equipment is air conditioner, medical equipment, appliances, or any other devices requiring power to operate.

38. The method of claim 33, wherein the user is a person, business, hospital or store.

39. A method comprising:
retrieving one or more parameters associated with a user, wherein the one or more parameters are agreed to by the user prior to using a system; and
deliver power to the user's vehicle based on the one or more parameters.

40. The method of claim 39, the method further comprising:
obtaining power from the user's vehicle based on the one or more parameters.

41. The method of claim 39, the method further comprising:
identifying a power provider, wherein the power delivered to the user's vehicle is from the power provider.

42. The method of claim 39, the method further comprising:
allowing the user to negotiate or accept predetermined the one or more parameters.

43. The method of claim 39, the method further comprising:
determining validity of the one or more parameters;
determining the amount of power to be delivered to the user's vehicle;
determining expected available power;
determining completion time for delivering power to the user's vehicle; and
displaying the completion time to the user.

44. A method comprising:
allowing a user to negotiate one or more parameters with at least one power provider; and
allowing the user to purchase power from the at least one power provider based on the one or more parameters.

45. The method of claim 44, the method further comprising:
allowing the user to charge a battery or operate equipment using the purchased power.

46. A system comprising:
a bidirectional power connection configured to obtain power from and deliver power to at least one power provider; and
at least one bidirectional power port configured to deliver power to and obtain power from at least one vehicle,
wherein power obtained from the at least one power provider is delivered to the at least one vehicle and wherein the power obtained from the at least one vehicle is delivered to the at least one power provider.
